(19) United States
(12) Patent Application Publication
(10) Pub. No.: US 2021/0282365 A1
(43) Pub. Date: Sep. 16, 2021

(54) Pet feeding system

(71) Applicant: Jeffrey Causby, Chesapeake Beach, MD (US)

(72) Inventor: Jeffrey Causby, Chesapeake Beach, MD (US)

(21) Appl. No.: 16/820,117

(22) Filed: Mar. 16, 2020

(51) Int. Cl. A01K 5/01; F16B 47/00

(52) U.S. Cl. CPC A01K 5/0135; F16B 47/00

(57) ABSTRACT

The present invention is a pet feeding system which slows the rate of eating for an animal or pet. The system is in the form of a tray or bowl shaped receptacle with feeding impediments positioned thereon. The impediments are shaped to create nooks which will trap food therein, causing the animal to take its time while feeding. A matrix of suction cups positioned beneath the receptacle allows for vertical mounting of the receptacle. Vertical positioning forces the head of the animal or pet up, which creates an unusual feeding position which naturally slows the rate of feeding.

### FIELD OF THE INVENTION

The present invention relates generally to pet feeding dishes. More specifically, the present invention is a pet feeding dish which can control the rate of pet feeding.

### BACKGROUND OF THE INVENTION

Pet feeding dishes comprise a generally bowl-shaped structure into which food is placed upon presentation to the pet. These types of generic pet food dishes are usually sized to accommodate an amount of food that is necessary for the pet's mealtime ration. Nevertheless, placement of the necessary amount of food in the generic feeding dish typically results in the animal trying to gobble the food as quickly as possible. The rate of eating can contribute to excessive weight gain, especially for pets kept primarily indoors.

Although there have been numerous differing types of pet feeding dish designs proposed for use, none of these designs have described a structure which is capable of compelling the pet to eat the mealtime ration at a slower pace. Some devices include raised portions of the dish which provide “obstacles” that impede the animals feeding. These suffer from the drawback that the pet will try to lick more aggressively which usually results in displacement of the bowl and a general mess after eating.

### SUMMARY OF THE INVENTION

The present invention is a pet feeding system which slows the rate of eating for an animal or pet.

The system is in the form of a tray or bowl shaped receptacle with feeding impediments positioned thereon. The impediments are shaped to create nooks which will trap food therein, causing the animal to take its time while feeding. A matrix of suction cups positioned beneath the receptacle allows for vertical mounting of the receptacle. Vertical positioning forces the head of the animal or pet up, which creates an unusual feeding position which naturally slows the rate of feeding.

### BRIEF DESCRIPTION OF THE DRAWINGS

FIG. 1 is a top perspective view of the feeding dish of the present invention.

FIG. 2 is a plan view of the bottom of the dish.

FIG. 3 is a side view of the dish illustrating surface features.

### DETAILED DESCRIPTION OF THE INVENTION

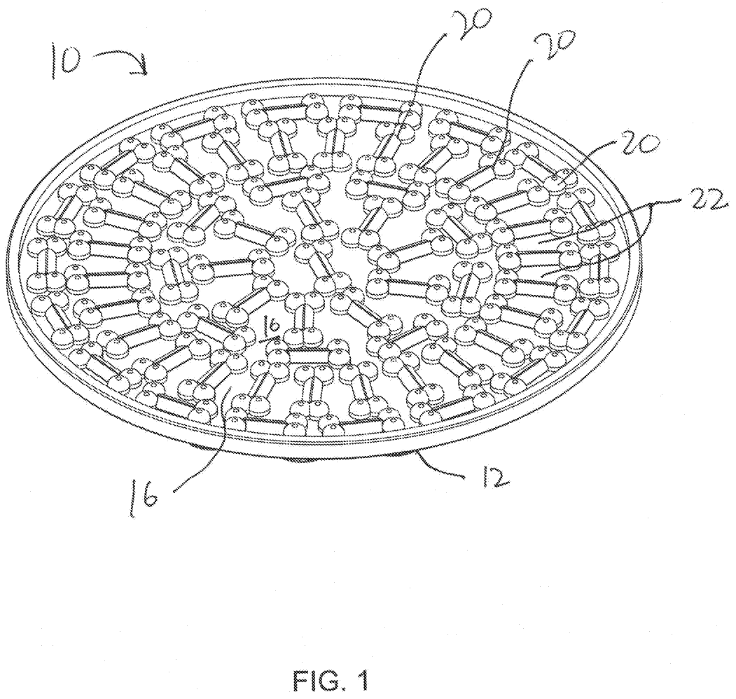

As seen in FIGS. 1-3 the present invention is a pet feeding dish or receptacle, generally indicated by the numeral 10. It can be seen that the receptacle or dish 10 is generally circular having a central depression. However, this shape is arbitrary and any shape and size providing a large enough feeding area for a typical house pet is sufficient. The dish 10 may be of a material that is weather resistant, durable, tough, tear-resistant, flexible, and/or lightweight such as a rigid non-toxic plastic or rubber material. The dish 10 has a base 12 having a bottom surface 14 and a top surface 16.

As best shown in FIG. 1, a plurality of upwardly protruding formations or impediments 20. The impediments 20, together with the base top surface 16 define a plurality of furrows 22 or depressions into which pockets of pet food are disposed upon initiation of the pet feeding process. It should be noted here that the type of food to be used with the present system would be a paste or similar consistency to allow the food to remain on the receptacle 10 (in the depressions 22) even when the receptacle is in the vertical position. Food having the consistency of peanut butter is optimal for use with this system 10, as it can be placed on the receptacle and not drip or run even if the receptacle 10 is vertical, The series of depressions tend to force the pet to reach into each of the depressions as by licking, thus providing a slowing action to the eating process. Additionally, the impediments 20 serve to provide a relatively more even dispersal of pet food throughout the receptacle. As can be seen in FIG. 1 the impediments 20 themselves are preferably contoured to provide “nooks” or smaller depressions and crevices to form therein; however it is to be appreciated that the impressions may have any cross-sectional shape that provides depressions 22, wherein several examples may include triangular, or square shapes. The exemplary shape and configuration of the impediments show one embodiment that is the preferred mode of practicing the present invention; nevertheless, it is to be understood that any structure which is adapted to cause significant disruption in the pet's eating behavior may fall within the scope of the present invention. The indentations as shown are approximately 1 inch in depth, however it is contemplated that indentations having a depth within the range of 0.5 inches to 1.5 inches may adequately retard the pet's eating speed and thus serve the intended purpose of the present invention.

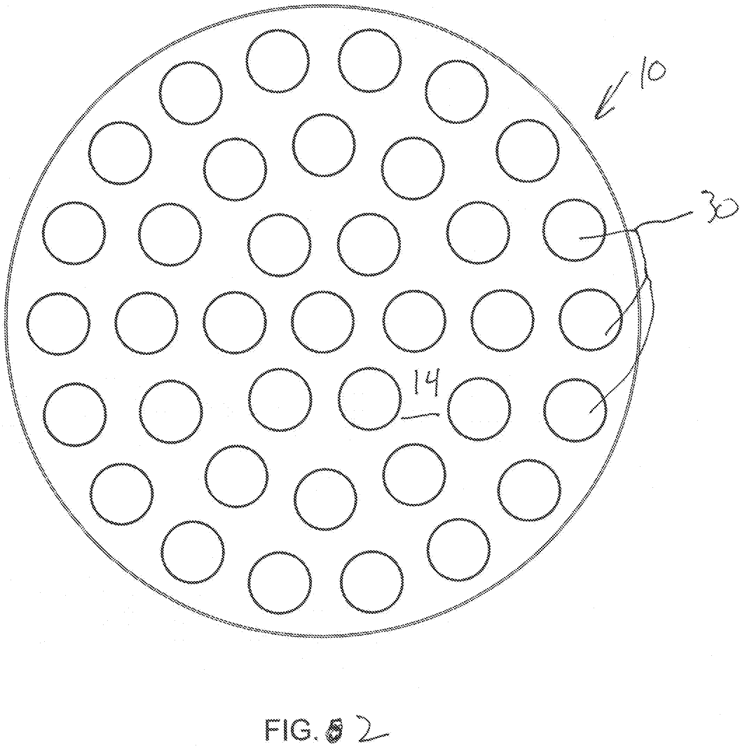

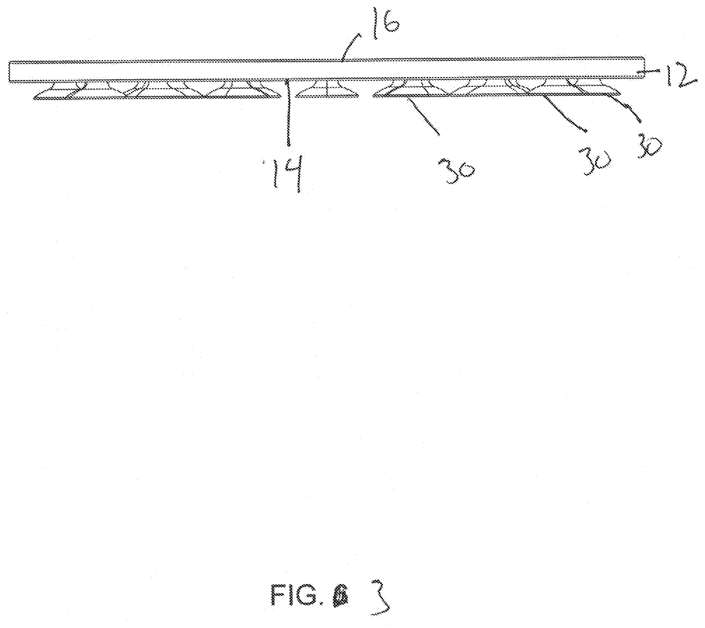

With particular reference to FIGS. 2 and 3, the suction cup arrangement is shown in detail. The suction cups 30 are regularly spaced and sized to fit a plurality onto the bottom surface 14 of the base 12. Both the receptacle 10 and the suction cups 30 are preferably made of the same materials so that the receptacle 10 and cups 30 can be formed at the same time. Alternatively, the suction cups 30 may be made of a more elastic rubberized material to enhance gripping ability. The size, and depth of the cups 30 will affect their ability to stay affixed to a vertical surface. In a key aspect of the invention, the cups 30 should provide sufficient gripping power to maintain the receptacle on a vertical surface when a pet is feeding. Accordingly, the cups 30 will require one to use several foot pounds of torque to remove the receptacle, which corresponds to a hard pull for an average adult. The amount and number of suction cups 20 required to create this resistance to removal of the receptacle 10 from a vertical surface is within the skill of one familiar with the art.

In use, the receptacle 10 is filled with a paste like foodstuff for the pet to eat. The receptacle 10 is then positioned on a vertical surface for the pet to feed. It can be appreciated that this vertical orientation forces the pet's head up, which is an unnatural position. This position naturally slows the pets eating, in combination with the impediments 20. Thus, the inventive device uses two methods to slow the pets eating.

What is claimed is:

1. A pet feeding system comprising:
a receptacle, said receptacle having a top surface with a plurality of raised impediments formed thereon, each of said raised impediments having depressions formed therein;
said receptacle having a bottom surface with a series of regularly spaced attachment members positioned thereon, said attachment members allowing for vertical placement of said receptacle when a pet is feeding.

2. The system of claim 1 wherein said raised impediments create depressions within which foodstuff may be positioned.

3. The system of claim 1 wherein said attachment members are suction cups.

4. The system of claim 3 wherein said suction cups are formed of the same material as the receptacle.

5. The system of claim 2 wherein said foodstuff has a paste-like consistency.

6. A method of slowing pet feeding comprising the steps of:
providing a receptacle having top and bottom sides, said top side having raised impediments formed thereon and said bottom side having attachment members positioned thereon;
spreading a paste-like foodstuff on said top side;
positioning said receptacle vertically on a vertical surface;
wherein the combination of said impediments and said vertical positioning cooperate to slow the feeding of said pet.
